(19) United States
(12) Patent Application Publication
(10) Pub. No.: US 2026/0342491 A1
(43) Pub. Date: Oct. 29, 2026

(54) METHODS AND APPARATUSES FOR MEASUREMENT GAP CONFIGURATION

(71) Applicant: CHINA SATELLITE NETWORK INNOVATION CO., LTD, Beijing (CN)

(72) Inventors: Dongqing QI, Beijing (CN); Ge MANG, Beijing (CN); Gaojian WANG, Beijing (CN); Dianting CHI, Beijing (CN); Rong GAO, Beijing (CN)

(73) Assignee: CHINA SATELLITE NETWORK INNOVATION CO., LTD, Beijing (CN)

(21) Appl. No.: 19/715,187

(22) Filed: Jun. 22, 2026

Related U.S. Application Data
(63) Continuation of application No. PCT/CN2025/123400, filed on Sep. 23, 2025.

(30) Foreign Application Priority Data
Apr. 24, 2025 (CN) 202510526685.1

(51) Int. Cl. H04L 5/00; H04L 43/0817

(52) U.S. Cl. CPC H04L 5/0005; H04L 43/0817

(57) ABSTRACT

An apparatus for measurement gap configuration at a network device or a network device side for at least one measurement gap corresponding to a reference signal time-domain position of an inter-frequency neighboring cell. The reference signal has at least one time offset and is used for a terminal device to perform inter-frequency neighboring cell measurement. The apparatus for measurement gap configuration sends gap configuration information to the terminal device. The gap configuration information includes configuration information of at least one measurement gap. The apparatus for measurement gap configuration determines at least one measurement gap according to gap configuration information and measures a reference signal of an inter-frequency neighboring cell in the at least one measurement gap.

### CROSS REFERENCE TO RELATED APPLICATIONS

The present disclosure is a continuation of International Application No. PCT/CN2025/123400 filed on Sep. 23, 2025, which claims the priority to Chinese Patent Application No. 202510526685.1, filed on Apr. 24, 2025 and entitled “Methods and Apparatuses for Measurement Gap Configuration”, both of which are is incorporated herein in their entireties.

### FIELD

The present disclosure relates to the field of wireless communication access networks, and in particular, to methods and apparatuses for measurement gap configuration.

### BACKGROUND

In a communication system of inter-frequency networking, a terminal device may be simultaneously covered by a plurality of cells with different frequencies. In order to maintain service continuity of a terminal device in a Radio Resource Control (RRC) connected state, before the terminal device performs handover between cells of different frequencies, measurement of inter-frequency neighboring cells needs to be performed.

In an existing 3rd Generation Partnership Project (3GPP) technology, a base station (gNB) uses a reconfiguration message (RRCReconfiguration) to configure, for the terminal device, configuration information of a frequency that needs to be measured. Configuration modes of the configuration information include the following two types: one type is gap configuration information (GapConfig), and each piece of gap configuration information (GapConfig) can only configure a “single” measurement window which appears periodically; and the other is measurement object MeasObjectNR configuration, and each measurement object MeasObjectNR (each measurement object describes one frequency) may be configured with up to “two sets” of gap configuration information (GapConfig). Inter-frequency neighboring cell measurement is performed according to the measurement window determined by the configuration information.

### SUMMARY

In the existing 3GPP standard, each piece of gap configuration information (GapConfig) can only configure a single measurement window occurring periodically, and each measurement object MeasObjectNR can configure up to two sets of gap configuration information (GapConfig). Neither of the two measurement gap configuration modes can meet the measurement gap configuration requirements of a downlink coverage enhancement scenario of a satellite network.

In order to alleviate, mitigate or eliminate the technical problem, one aspect of the present disclosure provides an apparatus for measurement gap configuration, which is applied to a network device, wherein the apparatus includes: a first processor, configured to perform the following operations. At least one measurement gap corresponding to a reference signal time-domain position of an inter-frequency neighboring cell is configured, wherein the reference signal is configured with at least one time offset for performing inter-frequency neighboring cell measurement. The reference signal is, for example, a Synchronization Signal/PBCH Block (SSB), a Cell Reference Signal (CRS), and a Channel State Information Reference Signal (CSI-RS); and gap configuration information (GapConfig) is sent to the terminal device, wherein the gap configuration information (GapConfig) includes configuration information of the at least one measurement gap.

Another aspect of the present disclosure provides an apparatus for measurement gap configuration, which is applied to a terminal device, wherein the apparatus includes: a second processor, configured to perform the following operations. Gap configuration information (GapConfig) sent from a network device is received, wherein the gap configuration information (GapConfig) includes configuration information of a measurement gap corresponding to a reference signal time-domain position of an inter-frequency neighboring cell, and the reference signal is configured with at least one time offset. The at least one measurement gap is determined according to the gap configuration information (GapConfig). The reference signal of the inter-frequency neighboring cell is measured in the measurement gap.

Another aspect of the present disclosure provides a method for measurement gap configuration, which is applied to a network device. At least one measurement gap corresponding to a reference signal time-domain position of an inter-frequency neighboring cell is configured, wherein the reference signal is configured with at least one time offset for performing inter-frequency neighboring cell measurement, and the reference signal is, for example, a Synchronization Signal/PBCH Block (SSB), a Cell Reference Signal (CRS), and a Channel State Information Reference Signal (CSI-RS). Gap configuration information (GapConfig) is sent to the terminal device, wherein the gap configuration information (GapConfig) includes configuration information of the at least one measurement gap.

Another aspect of the present disclosure provides a method for measurement gap configuration, which is applied to a terminal device. Gap configuration information (GapConfig) sent from a network device is received, wherein the gap configuration information (GapConfig) includes configuration information of at least one measurement gap corresponding to a reference signal time-domain position of an inter-frequency neighboring cell, and the reference signal is configured to have at least one time offset. The at least one measurement gap is determined according to the gap configuration information (GapConfig). The reference signal of the inter-frequency neighboring cell is measured in the at least one measurement gap.

Another aspect of the present disclosure provides a network device, including a memory, a processor and a computer program stored on the memory and capable of running on the processor, wherein when executing the computer program, the processor implements the method for measurement gap configuration applied to a network device side.

Another aspect of the present disclosure provides a terminal device, including a memory, a processor and a computer program stored on the memory and capable of running on the processor, wherein when executing the computer program, the processor implements the method for measurement gap configuration applied to a terminal device side.

Another aspect of the present disclosure provides a computer-readable storage medium, wherein the computer-readable storage medium stores a computer program, which when executed by a processor of a computer device, implements the method applied to a network device side or a terminal device side.

Another aspect of the present disclosure provides a computer program product, wherein the computer program product includes a computer program, which when executed by a processor of a computer device, implements the method applied to a network device side or a terminal device side.

In order to make the described objects and other objects, features and advantages of the present disclosure more apparent and easily understood, hereinafter, illustrative embodiments will be exemplified and described in detail below in conjunction with the accompanying drawings.

### BRIEF DESCRIPTION OF THE DRAWINGS

Elements and features described in one figure or embodiment of the present disclosure may be combined with elements and features shown in one or more other FIGURES or embodiments. In addition, in the FIGURES, similar reference numerals refer to corresponding parts throughout several FIGURES, and may be used to indicate corresponding parts used in more than one embodiment.

The included accompanying drawings are used to provide further understanding of embodiments of the present disclosure, constitute a part of the description, are used to illustrate embodiments of the present disclosure, and serve to explain the principles of the present disclosure together with the text description. Apparently, the accompanying drawings in the following illustration merely relate to some embodiments of the present disclosure, and for a person of ordinary skill in the art, other accompanying drawings can also be obtained according to these accompanying drawings without involving any inventive effort. In the drawings:

FIG. 1 shows a schematic diagram of a configuration mode of gap configuration information (GapConfig) in the related art;

FIG. 2 shows a schematic diagram of time domain distribution of an SSB burst when an SSB periodicity is 20 ms in the related art;

FIG. 3 shows a schematic diagram of time domain distribution of an SSB burst when an SSB periodicity is 160 ms in the related art;

FIG. 4 shows a schematic diagram of deployment of base stations and cells based on downlink coverage enhancement in the related art;

FIG. 5 shows a schematic diagram showing that gap configuration cannot support measurement gap configuration after downlink coverage enhancement in the related art;

FIG. 6 shows another schematic diagram showing that gap configuration cannot support measurement gap configuration after downlink coverage enhancement in the related art;

FIG. 7 shows a schematic diagram of a communication system according to embodiments of the present disclosure;

FIG. 8 shows a schematic diagram of gap configuration information according to embodiments of the present disclosure;

FIG. 9 shows a schematic diagram of measurement object configuration according to embodiments of the present disclosure;

FIG. 10 shows a schematic diagram of configuring at least one measurement gap by cooperation of a short-periodicity measurement gap period and an indication information element according to embodiments of the present disclosure;

FIG. 11 shows a flowchart of a method for measurement gap configuration applied to a network device side according to embodiments of the present disclosure;

FIG. 12 shows a flowchart of a method for measurement gap configuration applied to a terminal device side according to embodiments of the present disclosure;

FIG. 13 shows a structural diagram of an apparatus for measurement gap configuration applied to a network device side according to embodiments of the present disclosure;

FIG. 14 shows a structural diagram of an apparatus for measurement gap configuration applied to a terminal device side according to embodiments of the present disclosure;

FIG. 15 shows a schematic diagram of a terminal device according to embodiments of the present disclosure; and

FIG. 16 shows a schematic diagram of composition of a network device according to embodiments of the present disclosure.

### DETAILED DESCRIPTION OF THE EMBODIMENTS

Hereinafter, the technical solutions in embodiments of the present disclosure will be described clearly and completely with reference to the accompanying drawings of the embodiments of the present disclosure. Obviously, the embodiments as described are only some of the embodiments of the present disclosure, and are not all of the embodiments. All other embodiments obtained by a person of ordinary skill in the art on the basis of the embodiments of the present disclosure without involving any inventive effort shall all fall within the scope of protection of the present disclosure.

It is to be noted that the terms “first”, “second”, etc. in the description, claims and drawings of the present disclosure are used to distinguish similar objects, and are not necessarily used to describe a specific sequence or a precedence order. It should be understood that the data so used may be interchanged where appropriate such that embodiments of the present disclosure described herein may be implemented in sequences other than those illustrated or described herein. In addition, terms “include” and “have” and any variations thereof are intended to cover a non-exclusive inclusion, for example, a process, method, apparatus, product or device which includes a series of steps or units is not necessarily limited to those steps or units that are clearly listed, but may include other steps or units that are not clearly listed or inherent to these processes, methods, products or devices.

In the illustration of the present description, unless otherwise specified, “and/or” describes an association relationship between associated objects, indicating that three relationships may exist, for example, “A and/or B” may indicate three cases: A exists individually, both A and B exist, and B exists individually, wherein A, B may be singular or plural. Moreover, in the illustration of the present disclosure, unless otherwise specified, “a plurality of” means two or more. “At least one of” and similar expressions thereof refer to any combination of these items, including any combination of singular or plural items. For example, at least one of a, b, or c may represent: a, b, c, a-b, a-c, b-c, or a-b-c, where a, b, c may be singular or plural.

In the present description, in order to determine whether a specific condition is satisfied, expressions of “greater than” or “less than” may be used, however, this is merely to illustrate one example and is not intended to exclude the use of “greater than or equal to” or “less than or equal to”. A condition described as “greater than or equal to” may be replaced with “greater than”, and a condition described as “less than or equal to” may be replaced with “less than”, and a condition described as “greater than or equal to, and less than” may be replaced with “greater than, and less than or equal to”. Also, hereinafter, from “A” to “B” denotes at least one element among elements from A (including A) to B (including B).

In embodiments of the present disclosure, singular forms “a”, “the”, and the like include plural forms, and should be broadly understood as “one kind of” or “one type of”, rather than as defining the meaning of “a”; furthermore, the term “the” is to be understood as including both singular and plural forms, unless the context clearly indicates otherwise. In addition, the term “according to” should be understood as “at least partially according to . . . ”, and the term “based on” should be understood as “based at least partially on . . . ”, unless the context clearly indicates otherwise.

The description provides operation steps of methods as described in embodiments or flowcharts, but may include more or less operation steps on the basis of conventional or non-inventive effort. The sequence of steps listed in the embodiments is only one of many step execution sequences, and does not represent a unique execution sequence. During execution of an actual system or apparatus product, sequential or parallel execution may be performed according to the methods as shown in the embodiments or the accompanying drawings.

It should be noted that, in the embodiments of the present disclosure, any reference to some known solutions in the art such as software, assemblies and models should be regarded as exemplary only, and is intended solely to illustrate the feasibility of implementing the technical solutions of the present disclosure, and it does not imply that the applicant has used or necessarily will use such solutions.

In the present disclosure, embodiments are illustrated by terms used in a part of communication specifications (e.g. 3rd Generation Partnership Project (3GPP), European Telecommunications Standards Institute (ETSI), Extensible Radio Access Network (ERAN), and Open Radio Access Network (ORAN)), but these are merely examples for illustration. Various embodiments of the present disclosure can also be easily modified and applied in other communication systems.

In embodiments of the present disclosure, communication between devices in a communication system may be performed according to a communication protocol at any stage, and may include, for example, but not limited to, the following communication protocols: 1G (generation), 2G, 2.5G, 2.75G, 3G, 4G, 4.5G, and 5G, New Radio (NR), and the like, and/or other currently known or future developed communication protocols.

For ease of understanding, the technical terms involved in the embodiments of the present disclosure are explained below.
(1) Terminal Device: refers to a device that has a wireless transceiving function and can cooperate with a network device to provide a communication service for a user. The terminal device may be fixed or mobile, and may also be referred to as a Terminal, a User Equipment (UE), a User Terminal, a Mobile Terminal (MT), a User Agent, a Subscriber Station (SS), an Access Terminal (AT), a station or Mobile Station (MS), and so on.

For example, the terminal device may be a Mobile Phone, a tablet computer, a notebook computer, a wearable device, a Virtual Reality (VR) device, an Augmented Reality (AR) device, a wireless communication device, a wireless terminal in Industrial Control, a wireless terminal in Self Driving, a wireless terminal in Remote Medical Surgery, a wireless terminal in Smart Grid, a wireless terminal in Transportation Safety, a wireless terminal in Smart City, a wireless terminal in Smart Home, an Internet of Things (IoT) device, a Narrowband Internet of Things (NB-IoT) device, a Vehicle-to-Everything (V2X) device, a device in Device-to-Device Communication (D2D), an Enhanced Machine Type Communication (eMTC) device, a Reduced Capability (RedCap) device, a cellular phone, a cordless phone, a Session Initiation Protocol (SIP) phone, a Wireless Local Loop (WLL) station, a Personal Digital Assistant (PDA), a machine-type communication device, a laptop computer, a wireless modem, a digital camera, a client, a handheld device having a wireless communication function, a vehicle-mounted device, or a ship-borne device, etc.

In scenarios such as Internet of Things (IoT), the terminal device may also be a machine or an apparatus performing monitoring or measurement, and may include, for example but not limited to, a Machine Type Communication (MTC) terminal, a vehicle-mounted communication terminal, a Device to Device (D2D) terminal, a Machine to Machine (M2M) terminal, and the like.
(2) Network device: refers to a network-side device capable of communicating with the terminal device. The network device may be located at a satellite or the ground. The network device may also be referred to as a space base station, a space-borne base station, a satellite, a satellite communication node, a satellite network terminal device, a satellite communication module, or a base station. The network-side device may also be referred to as an access network device or a wireless access network device. The network-side device may be a Global System for Mobile Communication (GSM) carried by a satellite or a Base Transceiver Station (BTS) in a Code Division Multiple Access (CDMA) communication system, may also be a base station (NodeB, NB) in a Wideband Code Division Multiple Access (WCDMA) system carried by a satellite, may also be an evolved NodeB (eNB or eNodeB) in an LTE system carried by a satellite, may also be a base station in a terrestrial network or a Non-Terrestrial Network (NTN), for example, a base station (gNB) in a 5G network carried by a satellite, may also be a base station in a future network (for example, a 6G network) following a 5G network carried by a satellite, may also be a base station in a future evolved Public Land Mobile Network (PLMN) carried by a satellite, may also be a Transmission Reception Point (TRP) carried by a satellite, may also be a wireless controller in a Cloud Radio Access Network (CRAN) scenario carried by a satellite, and may also be an urban base station, a micro base station, a pico base station or a femto base station carried by a satellite, or the like. The base station may also be a terrestrial base station capable of communicating with the satellite, and may also be referred to as an Access Point (AP), a 5th generation node, a wireless point, a Transmission/Reception Point (TRP), and the latter have technical meanings equivalent thereto. The network device may also be a base station device borne by a High Altitude Platform Station (HAPS) that has a loitering capability, such as a large balloon or an airship, a base station device in a Roadside Unit (RSU), or a base station device in Vehicle-to-Everything, or the like. The network device may also be a broadcast transmitter, a Mobile Management Entity (MME), a gateway, a server, a Radio Network Controller (RNC), a Base Station Controller (BSC), and the like.

The base station may include, but is not limited to: a node B (NodeB or NB), an evolved node B (eNodeB or eNB), a 5G base station (gNB), an IAB host, and the like, and may further include a Remote Radio Head (RRH), a Remote Radio Unit (RRU), a relay, or a low-power node (such as femto and pico). And the term “base station” may include some or all functions thereof, and each base station may provide communication coverage for a particular geographic region. The term “cell” may refer to a base station and/or its coverage region, depending on the context in which the term is used.

Both the terminal device and the base station device may perform beamforming, but embodiments of the present disclosure are not limited thereto. In some embodiments, the terminal may or may not perform beamforming. And the base station may or may not perform beamforming. That is, only one of the terminal and the base station may perform beamforming, or neither the terminal nor the base station may perform beamforming. In the present disclosure, beam refers to a spatial flow of a signal in a wireless channel, and is formed by one or more antennas or antenna units, and such a forming process may be referred to as beamforming.

In addition, the term “network side” or “network device side” refers to one side of a network, which may be a certain base station, and may also include one or more network devices as described above. The term “terminal side” or “terminal device side” refers to a user or one side of a terminal, which may be a certain UE, and may also include one or more terminal devices as described above.

In embodiments of the present disclosure, configuration/indication means that the network device performs configuration/indication directly or indirectly through higher-layer signaling. Configuration/indication of higher-layer parameters may be introduced in the higher-layer signaling, and the higher-layer parameters refer to information fields and/or information units/information elements (IEs) in the higher-layer signaling.

In embodiments of the present disclosure, a reference signal is, for example, a Synchronization Signal/PBCH Block (SSB), a Cell Reference Signal (CRS), and a Channel State Information Reference Signal (CSI-RS).

In a communication system of inter-frequency networking, a terminal device may be simultaneously covered by a plurality of cells with different frequencies. In order to maintain service continuity of a terminal device in an RRC connected state, before the terminal device performs handover between cells of different frequencies, measurement of inter-frequency neighboring cells needs to be performed. In the existing 3GPP technology, when the terminal device performs inter-frequency measurement, an antenna needs to be adjusted to an inter-frequency frequency, and data transmission with a serving cell needs to be temporarily interrupted. In order to prevent the terminal device from failing to receive data of the serving cell when the terminal device performs inter-frequency measurement, the base station needs to use a reconfiguration message RRCReconfiguration to explicitly configure, for the terminal device, configuration information of a frequency to be measured, i.e., measurement gap configuration information (MeasGapConfig). The terminal device and the base station do not expect to perform data transceiving on the serving cell in a measurement window indicated by the MeasGapConfig, which ensures that the terminal device can securely detect a reference signal of an inter-frequency neighboring cell in the measurement window, and does not need to worry that the data of the serving cell fails to be received in the measurement window.

In one example, MeasGapConfig further includes three types of configurations: UE level (configured by a field gapUE), frequency range level (configured by fields gapFR1 and gapFR2), and frequency level (configured by a field gapToAddModList). Each type of configuration parameter is basically the same, and the configuration parameter is, for example, defined as gap configuration information (GapConfig).

In some embodiments, the 3GPP standard defines an information element of MeasGapConfig as follows:

| MeasGapConfig ::= | SEQUENCE { | |
|---|---|---|
| gapFR2 | SetupRelease { GapConfig } | OPTIONAL, -- Need M |

```
    ...,
    [[
```

| | | |
|---|---|---|
| gapFR1 | SetupRelease { GapConfig } | OPTIONAL, -- Need M |
| gapUE | SetupRelease { GapConfig } | OPTIONAL -- Need M |

```
    ]],
    [[
    gapToAddModList-r17 SEQUENCE (SIZE (1..maxNrofGapId-r17)) OF GapConfig-
```

| | |
|---|---|
| r17 | OPTIONAL, -- Need N |

gapToReleaseList-r17 SEQUENCE (SIZE (1..maxNrofGapId-r17)) OF MeasGapId-

| | |
|---|---|
| r17 | OPTIONAL, -- Need N |

```
  ...omitted...
    ]]
  }
```

wherein the 3GPP standard defines an information element of the gap configuration information (GapConfig) as follows:

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6}, |
| mgrp | ENUMERATED {ms20, ms40, ms80, ms160}, |
| mgta | ENUMERATED {ms0, ms0dot25, ms0dot5}, |

```
    ...,
  ...omitted...
    [[
  ...omitted...
```

| | |
|---|---|
| mgl-r16 | ENUMERATED {ms10, ms20} |

```
OPTIONAL -- Cond PRS
    ]]
  }
  For example, an information element of the gap configuration information (GapConfig)-
r17 of the 3GPP standard release 17 is defined as follows:
```

| | |
|---|---|
| GapConfig-r17 ::= | SEQUENCE { |
| measGapId-r17 | MeasGapId-r17, |
| gapType-r17 | ENUMERATED {perUE, perFR1, perFR2}, |
| gapOffset-r17 | INTEGER (0..159), |
| mgl-r17 | ENUMERATED {ms1, ms1dot5, ms2, ms3, ms3dot5, ms4, ms5, |

ms5dot5, ms6, ms10, ms20},

| | |
|---|---|
| mgrp-r17 | ENUMERATED {ms20, ms40, ms80, ms160}, |
| mgta-r17 | ENUMERATED {ms0, ms0dot25, ms0dot5, ms0dot75}, |

```
  ...omitted...
    ...
  }
```

In the described structure, main parameters for describing a gap measurement window in the gap configuration information (GapConfig) are:
gapOffset: measurement gap repetition period, offset of measurement gap start time;
mgl: measurement gap length;
mgrp: measurement gap repetition period;
mgta: measurement gap timing advance, advance amount of measurement gap start time.

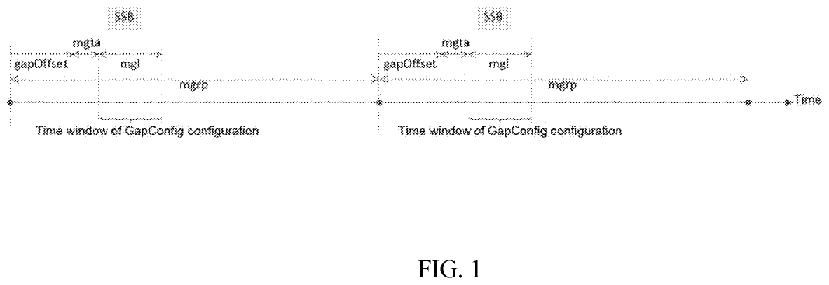

As shown in FIG. 1, by the described parameters, gap configuration information (GapConfig) may describe a “single” measurement window which appears periodically; a terminal device performs inter-frequency neighboring cell measurement in the measurement window, for example, a reference signal of a neighboring cell to be measured is a Synchronization Signal/PBCH Block (SSB), and a measurement window configured by the gap configuration information (GapConfig) needs to include a time-domain position where an SSB of a neighboring cell is located.

In some embodiments, each piece of frequency configuration information of MeasGapConfig is borne in one measurement object (MeasObject). In the 3GPP standard, a measurement object for 5G (NR), i.e. MeasObjectNR is defined as follows: the measurement object (MeasObjectNR) specifies related information applicable for intra/inter-frequency measurements of Synchronization Signal/Physical Broadcast Channel (SS/PBCH) blocks and/or intra/inter-frequency measurements of Channel State Information-Reference Signal (CSI-RS) (The IE MeasObjectNR specifies information applicable for SS/PBCH block(s) intra/inter-frequency measurements and/or CSI-RS intra/inter-frequency measurements).

The 3GPP standard introduces a parallel measurement gap function in Release 17, and for the measurement object MeasObjectNR with a frequency of 5G NTN, at most two sets of gap configuration information (GapConfig) can be associated. The existing 3GPP standard defines a data structure of MeasObjectNR in an air interface as follows, and the following data structure uses information elements associatedMeasGapSSB-r17 and associatedMeasGapSSB2-v1720 to indicate two sets of gap configuration information (GapConfig) associated with the measurement object MeasObjectNR:

| MeasObjectNR ::= | SEQUENCE { | |
|---|---|---|
| ssbFrequency | ARFCN-ValueNR | OPTIONAL, -- Cond |

SSBorAssociatedSSB

| | | |
|---|---|---|
| ssbSubcarrierSpacing | SubcarrierSpacing | OPTIONAL, -- Cond |

SSBorAssociatedSSB

| | | |
|---|---|---|
| smtc1 | SSB-MTC | OPTIONAL, -- Cond |

SSBorAssociatedSSB

| | | |
|---|---|---|
| smtc2 | SSB-MTC2 | OPTIONAL, -- Cond IntraFreqConnected |

```
  ...omitted...
    ...,
  ...omitted...
    [[
```

| | | |
|---|---|---|
| associatedMeasGapSSB-r17 | MeasGapId-r17 | OPTIONAL, -- Need R |

```
  ...omitted...
    ]],
    [[
```

| | | |
|---|---|---|
| associatedMeasGapSSB2-v1720 | MeasGapId-r17 | OPTIONAL, -- Cond |

```
AssociatedGapSSB
  ...omitted...
    ]],
  ...omitted...
  }
```

In summary, in the related art, each piece of gap configuration information (GapConfig) can only configure a “single” measurement window occurring periodically, and each measurement object MeasObjectNR (each measurement object describes one frequency) can configure up to “two sets” of gap configuration information (GapConfig). The measurement gap configuration mode cannot meet the measurement gap configuration requirements of a downlink coverage enhancement scenario of a satellite network. The specific analysis is as follows:
in a downlink coverage enhancement scenario, in order to cover a wide ground region with a limited number of satellite antennas, a single antenna may serve more wave positions in a time division manner by extending a “reference signal default period”; and taking the reference signal being an SBS as an example, correspondingly, the wave position refers to a coverage region of a beam transmitting an SSB on the ground.

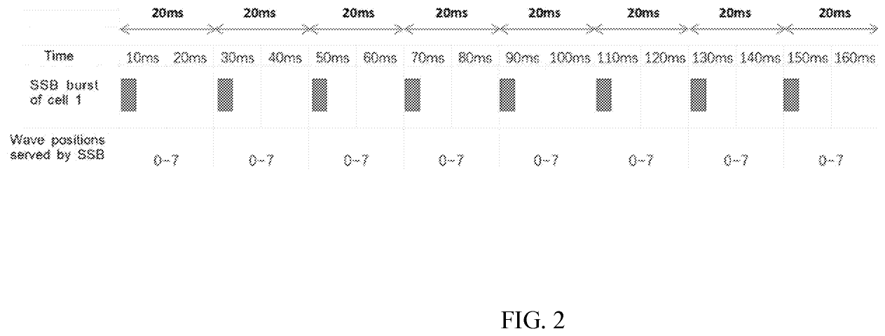

Before an SSB default periodicity is extended, the SSB default periodicity is 20 ms. When initially searching for a cell, the terminal device uses the default periodicity of 20 ms to detect an SSB. Reference is made to 3GPP TS 38.213: “For initial cell selection, a user equipment (UE) may assume that half frames with Synchronization Signal/Physical Broadcast Channel (SS/PBCH) blocks occur with a periodicity of 2 frames”. In order to ensure that the terminal device accesses a certain cell stably, the base station also needs to set an SSB periodicity (ssb-periodicityServingCell) of the cell to be 20 ms, or set same to be shorter than 20 ms. In one example, as shown in FIG. 2, taking SSB pattern case C as an example, when the SSB periodicity is 20 ms, an “SSB burst” formed by eight time-division SSBs are concentrated in the first 2 ms of every two frames (20 ms) (in FIG. 2, each rectangular block represents one SSB burst, and there are up to eight time-division SSBs in each SSB burst). In this way, a single SSB beam can provide service for eight wave positions in time division, and the eight wave positions can belong to the same cell.

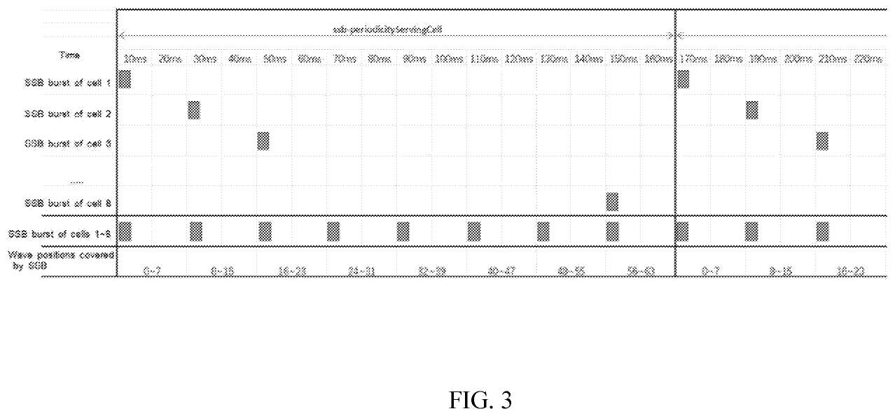

To meet the requirements of the downlink coverage enhancement scenario, the 3GPP standard determines in release 19 to extend the SSB default periodicity from 20 ms to 160 ms. As shown in FIG. 3, FIG. 3 shows a schematic diagram of a typical time domain distribution of an SSB burst when an SSB periodicity (SSB-periodicityservingCell) is 160 ms. When the SSB periodicity is 160 ms, from the perspective of the terminal device, the SSB appears once every 160 ms; and from the perspective of the base station, eight SSBs (the eight SSBs constitute one SSB burst) may be sent every 20 ms, and belong to the same cell. In the periodicity of 160 ms, there are eight SSB bursts which belong to eight “asynchronous” cells respectively, and each cell can provide service for eight wave positions. In this way, a single SSB beam can serve up to 64 wave positions in the 160 ms periodicity to implement downlink coverage enhancement.

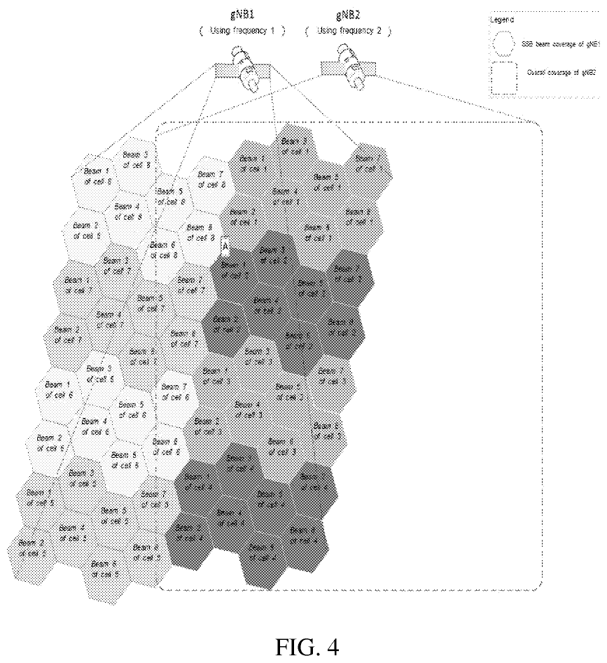

The downlink coverage enhancement technique may increase the satellite coverage, but may make the configuration of MeasGapConfig more complex. Taking the downlink coverage enhancement scenario in which the SSB periodicity is 160 ms as an example, a typical cell deployment is as shown in FIG. 4. gNB1 includes eight cells which are asynchronous with each other, the SSBs of the cells use the same frequency, i.e. frequency1, and each cell covers eight wave positions. gNB1 uses one SSB beam to service the 64 beams. A certain terminal device A resides on another gNB2 (which may be a TN or NTN base station), and SSBs of the gNB2 are deployed on a frequency, i.e. frequency2 different from that of the SSBs of the gNB1 (i.e. an inter-frequency relationship exists between the gNB1 and the gNB2). The user terminal A is in an RRC connected state and needs to perform inter-frequency measurement on the SSBs of the gNB1, so as to perform cell handover from gNB2 to gNB1. For the cell handover, there are mainly two gap configuration modes as follows:

### (1) Simple Configuration Scenario:

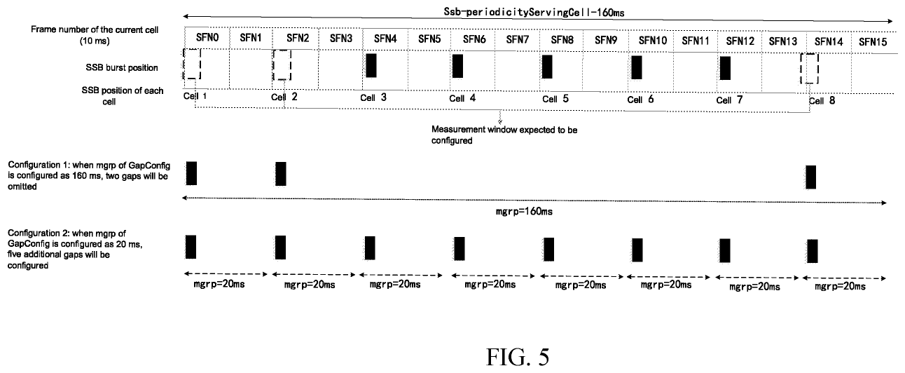

As shown in FIG. 4, it is assumed that the gNB2 can accurately learn the position of the terminal device A and the SSB beam distribution of the gNB1. That is, the gNB2 can accurately learn that the terminal device A is at a junction position of three beams of the gNB1, and when the gNB2 configures MeasGapConfig of the gNB1 for the terminal device A, the measurement window needs to include “beam 2 of cell 1”, “beam 1 of cell 2”, and “beam 8 of cell 8” of the gNB1. In this scenario, the measurement window expected to be configured by the GapConfig (i.e. the measurement window meeting practical requirements) is the time-domain positions where the dotted boxes in FIG. 5 are located.

However, in the related art, the GapConfig structure does not support such configuration of “asynchronous neighboring cell”, and the following configuration defects occur, as shown in FIG. 5:

Configuration 1: if the measurement gap period mgrp is set as 160 ms, only one measurement window can be configured in 160 ms, for example, the light gray window of configuration 1 in FIG. 5, that is, the first window in configuration 1. In this way, two windows may be missed, for example, the dark gray windows in configuration 1, i.e. the second window and the third window in configuration 1; and in FIG. 5, the dark gray windows are not windows configured in configuration 1, but are actually missed windows which should have been configured. Hence, configuration 1 may cause the terminal device A to be unable to perform handover to the cell 2 and the cell 8. Even if the parallel measurement gap function is used, only two measurement windows can be configured, and one window will still be missed.

Configuration 2: If the measurement gap period mgrp is set as 20 ms, there are 8 measurement windows in the SSB periodicity of 160 ms, such as all the time windows of configuration 2 in FIG. 5. Correspondingly, the third window to the seventh window are invalid time-domain positions, and within these invalid windows, the terminal device cannot measure neighboring cells, or perform data transmission with serving cells. Therefore, the mode of configuration 2 may cause resource waste.

### (2) Complex Configuration Scenario:

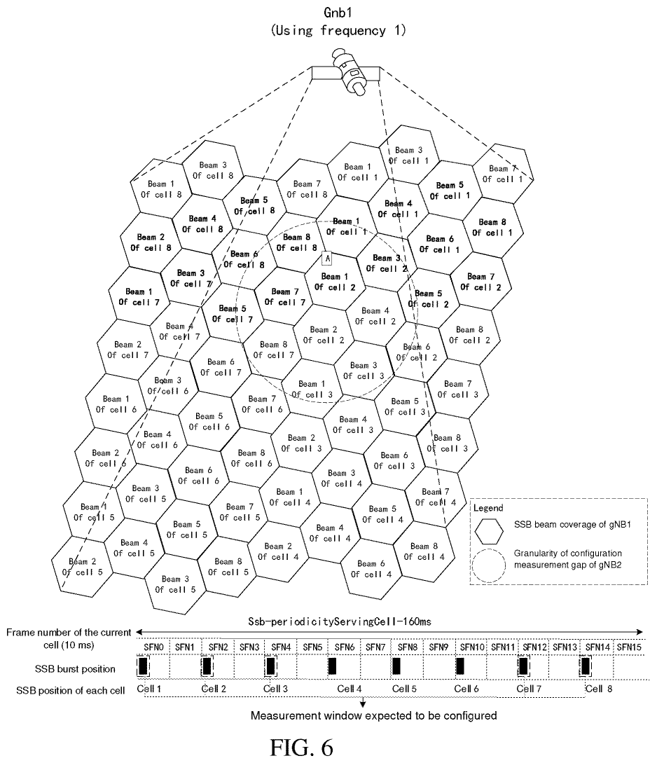

For user security and privacy protection, the terminal device generally does not report a position to the base station in real time, and therefore a gNB2 currently serving the terminal device cannot obtain an accurate position of the terminal device. On the other hand, it is very difficult for gNB2 to obtain beam distribution of gNB1. Generally, the gNB2 can only perform configuration of MeasGapConfig at a large granularity, for example, at a granularity of wave position or even cell, and does not perform fine and differential configuration based on the accurate position of the terminal device. As shown in FIG. 6, the SSB periodicity (ssb-periodicityServingCell) in FIG. 6 is set as 160 ms, and when the granularity for performing MeasGapConfig configuration by the gNB2 is the dashed circle region (the region may be wave positions or cells of the gNB2), a neighboring cell range to be configured may become cell 1, cell 2, cell 3, cell 7 and cell 8, and corresponding measurement windows expected to be configured are as shown by the dashed boxes in FIG. 6. In conclusion, in a more generic scenario, measurement gap configuration is more complex, and with reference to configuration 1 and configuration 2, configuration solutions in the related art are less applicable.

In order to solve the problem in the related art that the measurement gap configuration cannot meet the measurement gap configuration requirements of a downlink coverage enhancement scenario of a satellite network, the present disclosure proposes the following embodiments.

### Embodiments of First Aspect

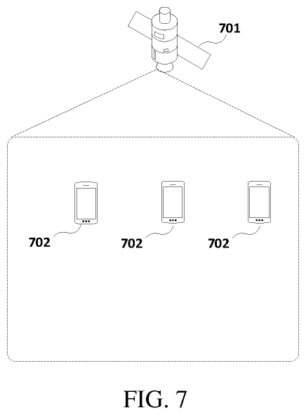

A first aspect of the present disclosure provides a communication system. As shown in FIG. 7, the communication system includes: a network device 701 and terminal devices 702. For simplicity, FIG. 7 only uses three terminal devices and one network device as an example for illustration, but the embodiments of the present disclosure are not limited thereto. It should be noted that, FIG. 7 shows that the three terminal devices 702 are all within the coverage of the network device 701, but the present disclosure is not limited thereto. In FIG. 7, the terminal devices 702 establish an RRC connection with the network device 701.

In embodiments of the present disclosure, the network device 701 and the terminal devices 702 may send existing services or services that may be implemented in the future. For example, these services may include, but are not limited to, enhanced Mobile Broadband (eMBB), massive Machine Type Communication (mMTC), and Ultra-Reliable and Low-Latency Communication (URLC), among others.

For example, the terminal devices 702 may send data to the network device 701, e.g., using licensed or unlicensed transmission mode. The network device 701 may receive data sent by one or more terminal devices 702, and feed back information, such as acknowledgement (ACK)/non-acknowledgement (NACK) information, to the terminal device 702. The terminal devices 702 may determine, according to the feedback information, that the transmission process ends, or may further perform new data transmission, or may perform data retransmission.

The network device 701 may send data to the terminal devices 702 in a unicast or multicast or broadcast method. The terminal devices 702 may receive data sent by one or more network devices (e.g., dual connection or multi-connection) via a downlink or data sent by the terminal devices 702 via a sidelink.

During implementation, the network device 701 is configured to perform the following operations: at least one measurement gap corresponding to a reference signal time-domain position of an inter-frequency neighboring cell is configured, wherein the reference signal is configured with at least one time offset for performing inter-frequency neighboring cell measurement; and gap configuration information (GapConfig) is sent to the terminal device 702, wherein the gap configuration information (GapConfig) includes configuration information of the at least one measurement gap.

In some embodiments, the network device 701 is configured to, when the terminal device 702 needs to perform inter-frequency neighboring cell measurement, configure at least one measurement gap corresponding to the reference signal time-domain position of the inter-frequency neighboring cell.

The terminal device 702 is configured to perform the following operations: gap configuration information (GapConfig) sent from the network device 701 is received, wherein the gap configuration information (GapConfig) includes configuration information of at least one measurement gap corresponding to a reference signal time-domain position of an inter-frequency neighboring cell, and the reference signal is configured with at least one time offset; the at least one measurement gap is determined according to the gap configuration information (GapConfig); and the reference signal of the inter-frequency neighboring cell is measured in the at least one measurement gap.

The network device 701 is a network device that has established an RRC connection with the terminal device 702, and is simply referred to a first network device. The inter-frequency neighboring cell corresponds to a second network device different from the first network device, and the reference signal of the inter-frequency neighboring cell can be configured with one or more time offsets. The frequencies of the first network device and the second network device are different from each other.

The measurement gap configured in this embodiment corresponds to the reference signal, that is, the number and time-domain positions of measurement gaps correspond to the number and time-domain positions of reference signals. Assuming that four time offsets exist in the reference signals of the inter-frequency neighboring cell, then the number of corresponding measurement gaps is also four, and each measurement gap corresponds to the reference signal time-domain position of one time offset. Here, “correspond to” means that the time-domain position of the measurement gap at least includes the reference signal time-domain position.

The present embodiment can avoid miss-configuration of a reference signal time-domain position of a frequency to be measured, and achieve flexible configuration of measurement gaps, such that configuration of measurement gaps may correspond to reference signal time-domain positions in a downlink coverage scenario. The present disclosure not only ensures the mobility of a terminal device in a connected state after downlink coverage enhancement, but also saves air interface resources and reduces unnecessary service interruption.

In some embodiments of the present disclosure, the network device 701 configures the at least one measurement gap corresponding to the reference signal time-domain position of the inter-frequency neighboring cell, includes:
in the gap configuration information (GapConfig), at least one piece of sub-gap configuration information SubGapConfig is configured, and at least one sub-gap has the same measurement gap period mgrp. Each piece of sub-gap configuration information SubGapConfig is used to determine a measurement gap having one time offset in the measurement gap period.

The sub-gap configuration information is mutually independent.

Correspondingly, the terminal device 702 determines the at least one measurement gap, includes:
the gap configuration information (GapConfig) includes at least one piece of sub-gap configuration information, and at least one sub-gap has the same measurement gap period; and a measurement gap having one time offset in the measurement gap period is determined according to the at least one piece of sub-gap configuration information.

In some specific embodiments, in the gap configuration information (GapConfig), at least one piece of sub-gap configuration information SubGapConfig is configured, includes:
a sub-gap configuration information list SubGapConfigList is provided in the gap configuration information (GapConfig), and the sub-gap configuration information list SubGapConfigList includes at least one piece of sub-gap configuration information SubGapConFIG. The number of pieces of sub-gap configuration information SubGapConfig in the sub-gap configuration list SubGapConfigList depends on implementation, and one possible implementation is that SubGapConfigList contains seven pieces of sub-gap configuration information SubGapConFIG.

In some embodiments, the sub-gap configuration information at least includes an independently configured: measurement gap start time offset, gapOffset. In some embodiments, the sub-gap configuration information further includes an independently configured: measurement gap length, mgl. In some embodiments, the sub-gap configuration information further includes an independently configured: advance amount of measurement gap start time, mgta. In some embodiments, the sub-gap configuration information further includes independently configured: measurement gap length, mgl and advance amount of measurement gap start time, mgta.

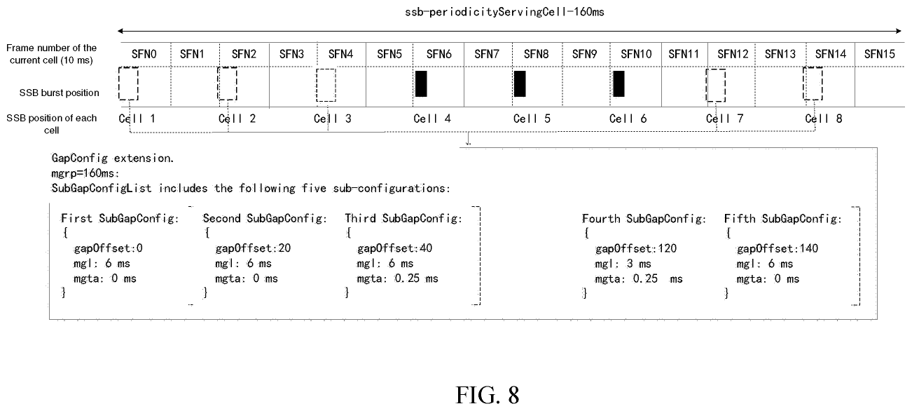

In the scenario of this embodiment as shown in FIG. 6, the measurement gap configuration is as shown in FIG. 8. FIG. 8 shows a schematic diagram of extended configuration of gap configuration information and configuration of at least one measurement sub-gap in a measurement gap period, mgrp. In one example, when the SSB periodicity is 160 ms, a total of five SSB burst positions, including cell 1, cell 2, cell 3, cell 7 and cell 8 are included (as shown by the dashed boxes in FIG. 8); and correspondingly, the measurement gap period mgrp is 160 ms, extended configuration of the gap configuration information (GapConfig) is as shown in the lower half part of FIG. 8, and the sub-gap configuration information list SubGapConfigList includes five pieces of sub-gap configuration information.

An embodiment of the sub-gap configuration information list SubGapConfigList is as follows:

```
  subGapConfigList-rxx SEQUENCE (SIZE(1..7)) OF SubGapConfig-rxx
  SubGapConfig-rxx ::= SEQUENCE {
```

| | |
|---|---|
| gapOffset-rxx | INTEGER(0..159), |

mgl-rxx
ENUMERATED{ms1,ms1dot5,ms2,ms3,ms3dot5,ms4,ms5,ms5dot5,ms6,ms10,ms20},

| | |
|---|---|
| mgta-rxx | ENUMERATED{ms0,ms0dot25,ms0dot5}, |

```
  ...
  }
```

The SubGapConfig-rxx is a sub-gap configuration structure, and the sub-gap configuration list subGapConfigList-rxx includes at least one sub-gap configuration structure.

In some embodiments of the present disclosure, the network device 701 configures the at least one measurement gap corresponding to the reference signal time-domain position of the inter-frequency neighboring cell, includes:
at least one piece of gap configuration information (GapConfig) is associated in the measurement object MeasObjectNR. Each piece of gap configuration information (GapConfig) correspondingly has a measurement gap of one time offset.

During specific implementation, parameters in each piece of gap configuration information may be configured independently and differently, and the gap configuration information includes parameters such as an advance amount of measurement gap start time mgta, a measurement gap length mgl, and a measurement gap period mrgp.

Correspondingly, the terminal device 702 determines the at least one measurement gap, includes:
a measurement object MeasObjectNR sent by the network device is received, wherein at least one piece of gap configuration information (GapConfig) is associated in the measurement object; wherein each piece of gap configuration information (GapConfig) corresponds to a measurement gap having one time offset; and at least one measurement gap is determined according to the at least one piece of gap configuration information (GapConfig) associated in the measurement object MeasObjectNR.

In some specific embodiments, at least one piece of gap configuration information (GapConfig) is associated in the measurement object MeasObjectNR, includes:
a measurement gap identifier list associatedMeasGapSSBList is configured in the measurement object MeasObjectNR; wherein the measurement gap identifier list associatedMeasGapSSBList is a list of measurement gap identifiers MeasGapId, and includes at least one measurement gap identifier MeasGapId, and each measurement gap identifier MeasGapId indicates one piece of gap configuration information. In some possible implementations, the measurement gap identifier list associatedMeasGapSSBList includes 7 measurement gap identifiers MeasGapId, and in the following embodiment, maxNrofAssociatedMeasGapSSB is set as 7.

The measurement gap identifier list associatedMeasGapSSBList is configured in the measurement object MeasObjectNR, for associating a plurality of release-17 measurement gaps GapConfig-r17. And it is agreed that, if the network device is configured with associatedMeasGapSSBList, the terminal device will ignore existing information elements, i.e.associatedMeasGapSSB-r17 and associatedMeasGapSSB2-v1720, i.e. information elements in the original measurement object MeasObjectNR. During specific implementation, existing information elements associatedMeasGapSSB-r17 and associatedMeasGapSSB2-v1720 may also not be ignored, and a method of using existing associatedMeasGapSSB-r17 and associatedMeasGapSSB2-v1720 and adding associatedMeasGapSSBList may also be used.

In some embodiments, at least one piece of gap configuration information (GapConfig) is associated in the measurement object MeasObjectNR, includes:
at least one measurement gap identifier is configured in the measurement object MeasObjectNR, and each measurement gap identifier indicates one piece of gap configuration information (GapConfig).

An embodiment of the measurement object MeasObjectNR is as follows, wherein [[associatedMeasGapSSBList . . . ] is newly added content:

| MeasObjectNR ::= | SEQUENCE { | |
|---|---|---|
| ssbFrequency | ARFCN-ValueNR | OPTIONAL, -- Cond |

SSBorAssociatedSSB

| | | |
|---|---|---|
| ssbSubcarrierSpacing | SubcarrierSpacing | OPTIONAL, -- Cond |

SSBorAssociatedSSB

| | | |
|---|---|---|
| smtc1 | SSB-MTC | OPTIONAL, -- Cond |

SSBorAssociatedSSB

| | | |
|---|---|---|
| smtc2 | SSB-MTC2 | OPTIONAL, -- Cond |

```
IntraFreqConnected
  ...omitted...
    ...,
  ...omitted...
    [[
```

| | | |
|---|---|---|
| associatedMeasGapSSB-r17 | MeasGapId-r17 | OPTIONAL, -- Need R |

```
  ...omitted...
    ]],
    [[
```

| | | |
|---|---|---|
| associatedMeasGapSSB2-v1720 | MeasGapId-r17 | OPTIONAL, -- Cond |

```
AssociatedGapSSB
  ...omitted...
    ]],
  ...omitted...
    [[
```

| | |
|---|---|
| associatedMeasGapSSBList | SEQUENCE (SIZE |

| | |
|---|---|
| (1..maxNrofAssociatedMeasGapSSB)) OF MeasGapId-r17 | OPTIONAL -- Need N |

```
    ]]
  }
```

wherein
maxNrofAssociatedMeasGapSSB INTEGER::=7—Maximum number of AssociatedMeasGapSSB

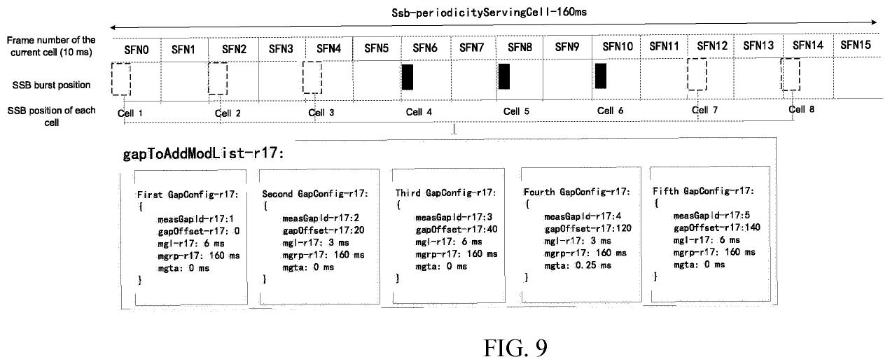

In the scenario of the embodiment as shown in FIG. 6, the measurement gap configuration is as shown in FIG. 9, FIG. 9 shows extended configuration of the measurement object, and shows a schematic diagram of an associated measurement gap identifier list associatedMeasGapSSBList in a measurement gap period mgrp, wherein the measurement gap identifier list associatedMeasGapSSBList includes at least one measGapID-r17. In one example, in FIG. 9, configuration is performed on a frequency level, that is, configuration is performed by a field gapToAddModList. In FIG. 9, when the SSB periodicity is 160 ms, five SSB burst positions, i.e. cell 1, cell 2, cell 3, cell 7 and cell 8 (as shown by dotted boxes in FIG. 9) are included; correspondingly, the measurement gap period mgrp is 160 ms, the content of extended configuration of the measurement object MeasObjectNR is as shown in the lower half part of FIG. 9, and a list associatedMeasGapSSBList is newly added into the measurement object MeasObjectNR, in which at least one measGapId-r17 is included, and the current scenario configuration is 1, 2, 3, 4, 5.

Correspondingly, the terminal device 702 determines at least one measurement gap according to the at least one piece of gap configuration information (GapConfig) associated in the measurement object MeasObjectNR, includes:
the measurement object MeasObjectNR includes a measurement gap identifier list associatedMeasGapSSBList, or the measurement object MeasObjectNR includes at least one measurement gap identifier; wherein the measurement gap identifier list includes at least one measurement gap identifier, and each measurement gap identifier indicates one piece of gap configuration information (GapConfig); and at least one measurement gap is determined according to the at least one measurement gap identifier.

In the two embodiments, extended configuration is performed both from the number of configuration gaps, and another method having better compatibility is to not increase the number of configuration gaps, and on the basis of multiplexing an existing gap configuration information structure, a shorter measurement gap period mgrp is configured to form a denser measurement window (i.e. a measurement gap), an indication information element enablePosition is then newly added to indicate to the terminal device which measurement gaps are valid and which measurement gaps can be ignored. In one example, the network device 701 configures the at least one measurement gap corresponding to the reference signal time-domain position of the inter-frequency neighboring cell, includes:
the measurement gap period configuration information and the indication information element enablePosition are configured. The measurement gap period mgrp in the measurement gap period configuration information is smaller than a reference signal period of a cell on a frequency to be measured. One possible way is to configure the measurement gap period mgrp as the smallest difference between reference signal time offsets between cells on the frequency to be measured. For example, if the SFN difference between the cells on the frequency to be measured is 2 frames, that is, the minimum difference between the reference signal time offsets between the cells is 20 ms, then the measurement gap period mgrp is set as 20 ms. The indication information element is used for indicating whether the at least one measurement gap in the measurement gap period is valid.

Correspondingly, the terminal device 702 determines the at least one measurement gap, includes:
the measurement gap period configuration information and the indication information element enablePosition sent by the network device are received; and according to the indication information element, a valid measurement gap in the reference signal period of the cell on the frequency to be measured is determined.

In this embodiment, an example of definition of the indication information element enablePosition is as follows: a new indication information element enablePosition may be defined according to a bitmap type, wherein the length of the bitmap is 8 bits (L=8) or 4 bits (L=4), optionally. 8 bits correspond to the multiple of the maximum period and the minimum period in the measurement gap period mgrp, i.e. 160 ms/20 ms. 4 bits correspond to 160 ms/40 ms or 80 ms/20 ms. In the indication information element enablePosition, the leftmost aₜₕ bit (a={1, 2, . . . . L}) being set as 1 indicates that measurement gaps in the (a+L*n)th measurement gap period mgrp (n={0, 1, 2, 3, . . . }) starting from the frame number SFN0 need to be valid, and the bit being set as 0 indicates that measurement gaps in the (a+L*n)th mgrp (n={0, 1, 2, 3, . . . }) starting from the frame number SFN0 can be ignored; where L represents the length of the indication information, and n is a natural number such as 0, 1, 2, 3.

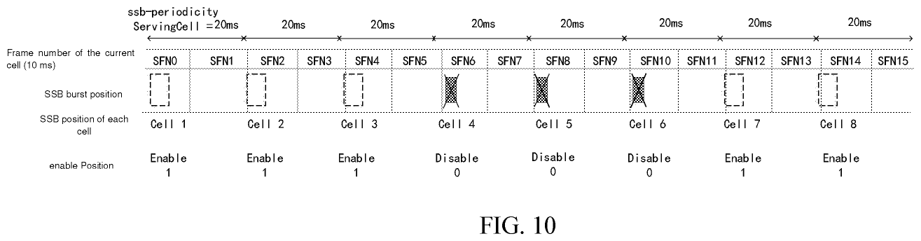

In the scenario of the embodiment shown in FIG. 6, the SSB periodicity of each cell is 160 ms, and the periodicity of the base station sending SSB is 20 ms. According to the method in this embodiment, the measurement gap period mgrp is set as the shorter 20 ms, and the value of L of the enablePosition is 160 ms/20 ms=8, i.e. 8 bits. For the region where the terminal device is located, the at least one measurement gap requiring to be configured is a measurement gap in the 1st, 2nd, 3rd, 7th, 8th . . . measurement gap period mgrp starting from SFN0. Therefore, the enablePosition is configured as 11100011. As shown in FIG. 10, measurement gaps at dotted boxes correspond to Enable, i.e. 1; and measurement gaps at X correspond to Disable, i.e. 0.

During specific implementation, the at least one measurement gap corresponding to the reference signal time-domain position may also be configured in other ways for configuring the at least one measurement gap corresponding to the reference signal time-domain position than the three ways.

The present disclosure is applicable to downlink coverage enhancement scenarios of satellite networks. The technical solution can achieve flexible configuration of measurement gaps, such that measurement gap configuration information may correspond to reference signal measurement windows in downlink coverage enhancement scenarios. The present disclosure not only ensures the mobility of a terminal in a connected state after downlink coverage enhancement, but also saves air interface resources and reduces unnecessary service interruption.

### Embodiments of Second Aspect

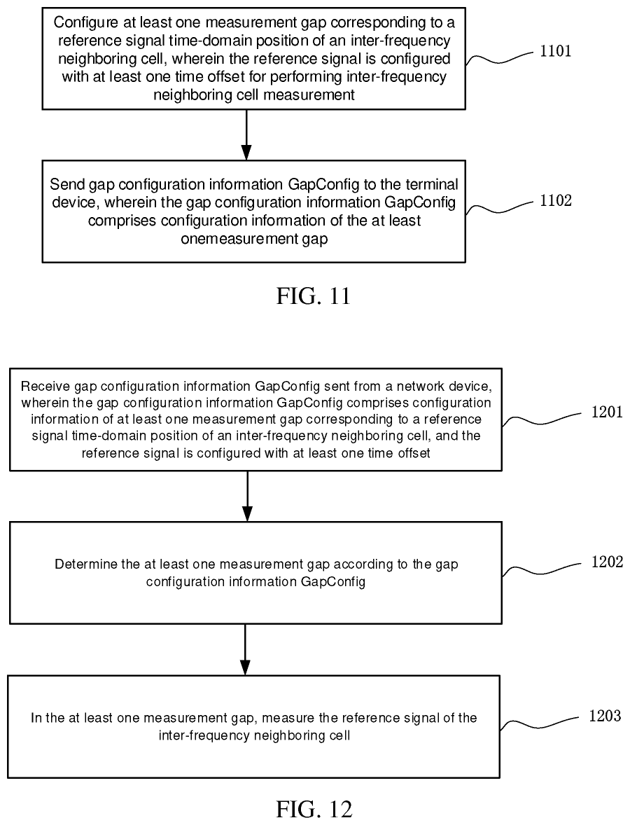

In some embodiments, further provided is a method for measurement gap configuration applied to a network device side, and as shown in FIG. 11, the method includes:
1101: at least one measurement gap corresponding to a reference signal time-domain position of an inter-frequency neighboring cell is configured, wherein the reference signal is configured with at least one time offset for performing inter-frequency neighboring cell measurement.

In some embodiments, when the terminal device needs to perform inter-frequency neighboring cell measurement, at least one measurement gap corresponding to the reference signal time-domain position of the inter-frequency neighboring cell is configured.

The terminal device establishes an RRC connection with the network device.
1102: gap configuration information (GapConfig) is sent to the terminal device, wherein the gap configuration information (GapConfig) includes configuration information of the at least one measurement gap.

It should be noted that, FIG. 11 only schematically illustrates the embodiments of the present disclosure, but the present disclosure is not limited thereto. For example, the execution sequence of the operations may be appropriately adjusted, and furthermore some other operations may be added or certain operations therein may be omitted. A person skilled in the art would have been able to make appropriate modifications according to the described content, without being limited to the disclosure in FIG. 11.

In some embodiments, step 1101 in which the at least one measurement gap corresponding to the reference signal time-domain position of the inter-frequency neighboring cell is configured, includes:
in the gap configuration information (GapConfig), at least one piece of sub-gap configuration information SubGapConfig is configured, and at least one sub-gap has the same measurement gap period.

Each piece of sub-gap configuration information SubGapConfig is used to determine a measurement gap having one time offset in the measurement gap period.

In some specific embodiments, in the gap configuration information (GapConfig), at least one piece of sub-gap configuration information SubGapConfig is configured, includes:
a sub-gap configuration information list SubGapConfigList is provided in the gap configuration information (GapConfig), and the sub-gap configuration information list SubGapConfigList includes at least one piece of sub-gap configuration information.

In this embodiment, extended configuration is performed on the gap configuration information (GapConfig), and the gap configuration information (GapConfig) subjected to extended configuration may configure at least one measurement sub-gap in one measurement gap period mrgp, wherein the configuration of each sub-gap at least includes a measurement gap start time offset gapOffset, and optionally includes parameters such as a measurement gap length mgl and an advance amount of measurement gap start time mgta.

In some embodiments, step 1101 in which the at least one measurement gap corresponding to the reference signal time-domain position of the inter-frequency neighboring cell is configured, includes:
at least one piece of gap configuration information (GapConfig) is associated in the measurement object MeasObjectNR.

Each piece of gap configuration information (GapConfig) corresponds to a measurement gap having one time offset.

During specific implementation, parameters in each piece of gap configuration information (GapConfig) may be configured independently and differently, and the gap configuration information includes parameters such as an advance amount of measurement gap start time mgta, a measurement gap length mgl, and a measurement gap period mrgp.

In some specific embodiments, a measurement gap identifier list associatedMeasGapSSBList is configured in the measurement object MeasObjectNR; wherein the measurement gap identifier list associatedMeasGapSSBList includes at least one measurement gap identifier, and each measurement gap identifier indicates one piece of gap configuration information; or at least one measurement gap identifier is configured in the measurement object MeasObjectNR, and each measurement gap identifier indicates one piece of gap configuration information (GapConfig).

In this embodiment, extended configuration is performed on the NR measurement object MeasObjectNR, and the MeasObjectNR subjected to extended configuration may be associated with a list composed of at least one piece of gap configuration information (GapConfig).

In some embodiments, step 1101 in which the at least one measurement gap corresponding to the reference signal time-domain position of the inter-frequency neighboring cell is configured, includes:
measurement gap period configuration information and an indication information element enablePosition are configured.

The measurement gap period indicated by the measurement gap period configuration information is smaller than a reference signal period of a cell on a frequency to be measured. In one possible implementation, the measurement gap period is configured as the smallest difference between reference signal time offsets between cells on the frequency to be measured. The indication information element is configured to indicate whether the at least one measurement gap in the measurement gap period to be measured is valid.

Only the steps or processes related to the present disclosure have been described above, but the present disclosure is not limited thereto. The method of the embodiments of the present disclosure can further include other steps or processes, and with regard to the specific content of these steps or processes, reference can be made to those in the related art.

Although the embodiments of the present disclosure have been described above by way of examples, the present disclosure is not limited thereto, and appropriate modification may be made on the basis of the embodiments as described above. For example, the embodiments may be used alone, or one or more of the embodiments may be combined with each other.

### Embodiments of Third Aspect

In some embodiments, further provided is a method for measurement gap configuration applied to a terminal device side, and as shown in FIG. 12, the method includes:
1201: gap configuration information (GapConfig) sent from a network device is received, wherein the gap configuration information (GapConfig) includes configuration information of at least one measurement gap corresponding to a reference signal time-domain position of an inter-frequency neighboring cell, and the reference signal is configured with at least one time offset.

The terminal device establishes an RRC connection with the network device.
1202: the at least one measurement gap is determined according to the gap configuration information (GapConfig).
1203: the reference signal of the inter-frequency neighboring cell is measured in the at least one measurement gap.

It should be noted that, FIG. 12 only schematically illustrates the embodiments of the present disclosure, but the present disclosure is not limited thereto. For example, the execution sequence of the operations may be appropriately adjusted, and furthermore some other operations may be added or certain operations therein may be omitted. A person skilled in the art would have been able to make appropriate modifications according to the described content, without being limited to the disclosure in FIG. 12.

In some embodiments, step 1202 in which the at least one measurement gap is determined, includes:
the gap configuration information (GapConfig) includes at least one piece of sub-gap configuration information, and at least one sub-gap has the same measurement gap period; and
a measurement gap having one time offset in the measurement gap period is determined according to the at least one piece of sub-gap configuration information.

In some embodiments, step 1202 in which the at least one measurement gap is determined, includes:
a measurement object MeasObjectNR sent by the network device is received, wherein at least one piece of gap configuration information (GapConfig) is associated in the measurement object MeasObjectNR; wherein each piece of gap configuration information (GapConfig) corresponds to a measurement gap having one time offset; and at least one measurement gap is determined according to the at least one piece of gap configuration information (GapConfig) associated in the measurement object MeasObjectNR.

In some embodiments, at least one measurement gap is determined according to the at least one piece of gap configuration information (GapConfig) associated in the measurement object MeasObjectNR, includes:
the measurement object MeasObjectNR includes a measurement gap identifier list associatedMeasGapSSBList, or the measurement object MeasObjectNR includes at least one measurement gap identifier; wherein the measurement gap identifier list associatedMeasGapSSBList includes at least one measurement gap identifier, and each measurement gap identifier indicates one piece of gap configuration information; and at least one measurement gap is determined according to the at least one measurement gap identifier.

In some embodiments, step 1202 in which the at least one measurement gap is determined, includes:
the measurement gap period configuration information and an indication information element enablePosition configured by the network device are received; wherein the measurement gap period indicated by the measurement gap period information is smaller than a reference signal period of a cell on a frequency to be measured; and according to the indication information element, a valid measurement gap in the reference signal period of the cell on the frequency to be measured is determined.

Only the steps or processes related to the present disclosure have been described above, but the present disclosure is not limited thereto. The method of the embodiments of the present disclosure can further include other steps or processes, and with regard to the specific content of these steps or processes, reference can be made to those in the related art.

Although the embodiments of the present disclosure have been described above by way of examples, the present disclosure is not limited thereto, and appropriate modification may be made on the basis of the embodiments as described above. For example, the embodiments may be used alone, or one or more of the embodiments may be combined with each other.

### Embodiments of Fourth Aspect

In some embodiments, further provided is an apparatus for measurement gap configuration applied to a network device side, wherein the apparatus may be for example, a network device, and may also be certain or some components or assemblies configured in the network device. Content same as that in the embodiments of the second aspect will not be described again.

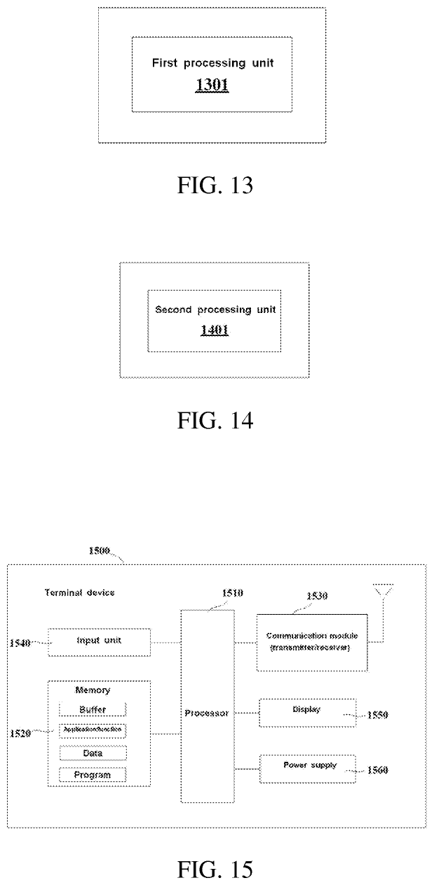

FIG. 13 is a schematic diagram of an apparatus for measurement gap configuration applied to a network device side according to embodiments of the present disclosure. Since the problem solving principle of the apparatus for measurement gap configuration applied to a network device side is the same as that of the method according to embodiments of the second aspect, for specific implementation thereof, reference can be made to the embodiments of the second aspect, and content same as the second aspect will not be repeated here.

As shown in FIG. 13, the apparatus for measurement gap configuration applied to the network device side includes a first processing unit 1301, wherein the first processing unit 1301 is configured to control the network device to execute the following operations:
at least one measurement gap corresponding to a reference signal time-domain position of an inter-frequency neighboring cell is configured, wherein the reference signal is configured with at least one time offset for performing inter-frequency neighboring cell measurement; and
gap configuration information (GapConfig) is sent to the terminal device, wherein the gap configuration information (GapConfig) includes configuration information of the at least one measurement gap.

In some embodiments, when the terminal device needs to perform inter-frequency neighboring cell measurement, at least one measurement gap corresponding to the reference signal time-domain position of the inter-frequency neighboring cell is configured. The terminal device establishes an RRC connection with the network device.

In some embodiments, the first processing unit 1301 is configured to configure the at least one measurement gap corresponding to the reference signal time-domain position of the inter-frequency neighboring cell, includes:
in the gap configuration information (GapConfig), at least one piece of sub-gap configuration information SubGapConfig is configured, and at least one sub-gap has the same measurement gap period,
wherein each piece of sub-gap configuration information SubGapConfig is used to determine a measurement gap having one time offset in the measurement gap period.

In some specific embodiments, a sub-gap configuration information list SubGapConfigList is provided in the gap configuration information (GapConfig), and the sub-gap configuration information list SubGapConfigList includes at least one piece of sub-gap configuration information.

The sub-gap configuration information at least includes a measurement gap start time offset gapOffset. The sub-gap configuration information further includes a measurement gap length mgl. The sub-gap configuration information further includes an advance amount of measurement gap start time, mgta. The sub-gap configuration information further includes measurement gap length, mgl and advance amount of measurement gap start time, mgta.

In some embodiments, the first processing unit 1301 is configured to configure the at least one measurement gap corresponding to the reference signal time-domain position of the inter-frequency neighboring cell, includes:
at least one piece of gap configuration information (GapConfig) is associated in the measurement object MeasObjectNR.

Each piece of gap configuration information (GapConfig) corresponds to a measurement gap having one time offset.

During specific implementation, parameters in each piece of gap configuration information may be configured independently and differently, and the gap configuration information includes parameters such as an advance amount of measurement gap start time mgta, a measurement gap length mgl, and a measurement gap period mrgp.

In some specific embodiments, at least one piece of gap configuration information (GapConfig) is associated in the measurement object, includes:
a measurement gap identifier list associatedMeasGapSSBList is configured in the measurement object MeasObjectNR; wherein the measurement gap identifier list associatedMeasGapSSBList includes at least one measurement gap identifier, and each measurement gap identifier indicates one piece of gap configuration information (GapConfig); or at least one measurement gap identifier is configured in the measurement object MeasObjectNR, and each measurement gap identifier indicates one piece of gap configuration information (GapConfig).

In some embodiments, the first processing unit 1301 is configured to configure the at least one measurement gap corresponding to the reference signal time-domain position of the inter-frequency neighboring cell, includes:
measurement gap period configuration information and an indication information element enablePosition are configured.

The measurement gap period indicated by the measurement gap period configuration information is smaller than a reference signal period of a cell on a frequency to be measured. In one possible implementation, the measurement gap period is configured as the smallest difference between reference signal time offsets between cells on the frequency to be measured. The indication information element is configured to indicate whether the at least one measurement gap in the measurement gap period to be measured is valid.

It should be noted that only the components related to the present disclosure have been described above, but the present disclosure is not limited thereto. The apparatus for measurement gap configuration applied to a network device side according to embodiments of the present disclosure can further include other components or modules; and for specific content of these components or modules, reference may be made to those in the related art.

Although the embodiments of the present disclosure have been described above by way of examples, the present disclosure is not limited thereto, and appropriate modification may be made on the basis of the embodiments as described above. For example, the embodiments may be used alone, or one or more of the embodiments may be combined with each other.

### Embodiments of Fifth Aspect

In some embodiments, further provided is an apparatus for measurement gap configuration applied to a terminal device side, wherein the apparatus may be for example, a network device, and may also be certain or some components or assemblies configured in the network device. Content same as that in the embodiments of the third aspect will not be described again.

FIG. 14 is a schematic diagram of an apparatus for measurement gap configuration applied to a terminal device side according to embodiments of the present disclosure. Since the problem solving principle of the apparatus for measurement gap configuration applied to a terminal device side is the same as that of the method according to embodiments of the third aspect, for specific implementation thereof, reference can be made to the embodiments of the third aspect, and content same as the second aspect will not be repeated here.

As shown in FIG. 14, the apparatus for measurement gap configuration applied to the terminal device side includes a second processing unit 1401, wherein the second processing unit 1401 is configured to execute the following operations:
gap configuration information (GapConfig) sent from a network device is received, wherein the gap configuration information (GapConfig) includes configuration information of at least one measurement gap corresponding to a reference signal time-domain position of an inter-frequency neighboring cell, and the reference signal is configured to have at least one time offset;
the at least one measurement gap is determined according to the gap configuration information GapConfig; and
the reference signal of the inter-frequency neighboring cell is measured in the at least one measurement gap.

The terminal device establishes an RRC connection with the network device. The at least one measurement gap is configured when the terminal device needs to perform inter-frequency neighboring cell measurement.

In some embodiments, the second processing unit 1401 determines the at least one measurement gap, includes:
the gap configuration information (GapConfig) includes at least one piece of sub-gap configuration information SubGapConfig, and at least one sub-gap has the same measurement gap period; and
a measurement gap having one time offset in the measurement gap period is determined according to the sub-gap configuration information in the at least one gap configuration GapConFIG.

In some embodiments, the second processing unit 1401 determines the at least one measurement gap, includes:
a measurement object MeasObjectNR sent by the network device is received, wherein at least one piece of gap configuration information (GapConfig) is associated in the measurement object MeasObjectNR; wherein each piece of gap configuration information (GapConfig) corresponds to a measurement gap having one time offset; and
at least one measurement gap is determined according to the at least one piece of gap configuration information (GapConfig) associated in the measurement object MeasObjectNR.

In some embodiments, the at least one measurement gap is determined according to the at least one piece of gap configuration information (GapConfig) associated in the measurement object MeasObjectNR, includes:
the measurement object MeasObjectNR includes a measurement gap identifier list associatedMeasGapSSBList, or the measurement object includes at least one measurement gap identifier; wherein the measurement gap identifier list associatedMeasGapSSBList includes at least one measurement gap identifier, and each measurement gap identifier indicates one piece of gap configuration information (GapConfig); and at least one measurement gap is determined according to the at least one measurement gap identifier.

In some embodiments, the second processing unit 1401 determines the at least one measurement gap, includes:
measurement gap period configuration information and an indication information element enablePosition sent by the network device are received; wherein the measurement gap period indicated by the measurement gap period configuration information is smaller than a reference signal period of a cell on a frequency to be measured; and
according to the indication information element, a valid measurement gap in the reference signal period of the cell on the frequency to be measured is determined.

It should be noted that only the components related to the present disclosure have been described above, but the present disclosure is not limited thereto. The apparatus for measurement gap configuration applied to a terminal device side according to embodiments of the present disclosure can further include other components or modules; and for specific content of these components or modules, reference may be made to those in the related art.

Although the embodiments of the present disclosure have been described above by way of examples, the present disclosure is not limited thereto, and appropriate modification may be made on the basis of the embodiments as described above. For example, the embodiments may be used alone, or one or more of the embodiments may be combined with each other.

The satellite network needs to increase the coverage of the cell by using a downlink coverage enhancement technique. A typical method in the downlink coverage enhancement technique is to extend the SSB periodicity, and deploy different asynchronous cells for different SSB bursts in the SSB periodicity. Such a method leads to a result that measurement gaps for SSB are no longer a simple periodicity distribution. According to the existing measurement gap configuration method, configuration omission of SSB time-domain positions will occur, such that inter-cell handover cannot be performed, thereby affecting service continuity of a terminal; or the configuration of measurement gaps is too dense, which affects service of a serving cell and causes waste of air interface resources.

The present disclosure provides a flexible configuration solution of measurement gaps, such that the measurement gap configuration may correspond to SSB measurement windows in downlink coverage enhancement scenarios. The present solution not only ensures the mobility of a terminal in a connected state after downlink coverage enhancement, but also saves air interface resources and reduces unnecessary service interruption.

The embodiments of the present disclosure further provide a terminal device, but the present disclosure is not limited thereto, and the terminal device may be other devices.

FIG. 15 shows a schematic diagram of a terminal device according to embodiments of the present disclosure. As shown in FIG. 15, the terminal device 1500 may include a processor 1510 and a memory 1520; wherein the memory 1520 stores data and program, and is coupled to the processor 1510. Notably, this figure is exemplary; and other types of structures may also be used to supplement or replace the structure, so as to achieve telecommunication or other functions.

For example, the processor 1510 may be configured to execute the program to implement a method for measurement gap configuration applied to a terminal device side.

As shown in FIG. 15, the terminal device 1500 can further include: a communication module 1530, an input unit 1540, a display 1550 and a power supply 1560. Functions of the components are similar to those in the related art, and will not be repeated herein. It should be noted that the terminal device 1500 does not necessarily include all the components shown in FIG. 15, and the components are not necessary. In addition, the terminal device 1500 may further include components that are not shown in FIG. 15, and reference may be made to the related art.

Embodiments of the present disclosure further provide a network device, which may be, for example, a base station, but the present disclosure is not limited thereto, and the network device may also be other network devices.

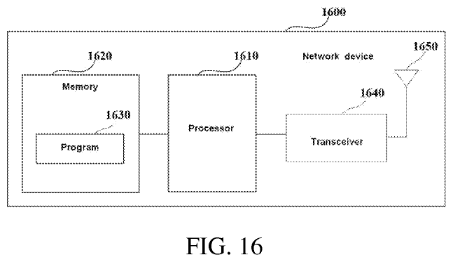

FIG. 16 shows a schematic diagram of composition of a network device according to embodiments of the present disclosure. As shown in FIG. 16, the network device 1600 may include: a processor 1610 (for example, a central processing unit (CPU)) and a memory 1620; wherein the memory 1620 is coupled to the processor 1610. The memory 1620 may store various data, and may also store a program 1630 of information processing, and the program 1630 is executed under control of the processor 1610.

For example, the processor 1610 may be configured to execute the program to implement a method for measurement gap configuration applied to a network device side.

In addition, as shown in FIG. 16, the network device 1600 can further include: a transceiver 1640, an antenna 1650, and the like. Functions of the components are similar to those in the related art, and will not be repeated herein. It is noted that the network device 1600 does not necessarily include all the components shown in FIG. 16. In addition, the network device 1600 may further include components that are not shown in FIG. 16, and reference may be made to the related art.

Embodiments of the present disclosure further provide a computer-readable program product, the computer program product includes a computer program, wherein when the computer program is executed by a processor of a computer device, the method for measurement gap configuration applied to a network device side is implemented, i.e. the method in the embodiments of the second aspect.

Embodiments of the present disclosure further provide a storage medium storing a computer-readable program, the storage medium stores a computer-readable program, wherein when the computer-readable program is executed by a processor of a computer device, the method for measurement gap configuration applied to a network device side is implemented, i.e. the method in the embodiments of the second aspect.

Embodiments of the present disclosure further provide a computer-readable program product, the computer program product includes a computer program, wherein when the computer program is executed by a processor of a computer device, the method for measurement gap configuration applied to a terminal device side is implemented, i.e. the method in the embodiments of the third aspect.

Embodiments of the present disclosure further provide a storage medium storing a computer-readable program, the storage medium stores a computer-readable program, wherein when the computer-readable program is executed by a processor of a computer device, the method for measurement gap configuration applied to a terminal device side is implemented, i.e. the method in the embodiments of the third aspect.

The apparatuses and methods as described above of the present disclosure may be implemented by hardware, or implemented by hardware in combination with software. The present disclosure relates to such a computer-readable program that, when executed by a logic component, enables the logic component to implement the apparatus or constituting components described above, or enables the logic component to implement the methods or steps as described above. The logic component is for example, a field programmable logic component, a microprocessor, a processor used in a computer. The present disclosure also relates to a storage medium such as a hard disk, a magnetic disk, an optical disk, a DVD, a flash memory for storing the program above.

The methods/apparatuses described in connection with the embodiments of the present disclosure may be embodied directly in hardware, in a software module executed by a processor, or in a combination of the two. For example, one or more of the functional block diagrams and/or one or more combinations of the functional block diagrams shown in the FIGURES may correspond to software modules of a computer program process, and may also correspond to hardware modules. These software modules may respectively correspond to the steps shown in the FIGURES. These hardware modules can be implemented, for example, by curing these software modules using field-programmable gate arrays (FPGAs).

The software module may reside in an RAM memory, a flash memory, an ROM memory, an EPROM memory, an EEPROM memory, a register, a hard disk, a removable disk, a CD-ROM, or any other form of storage medium known in the art. A storage medium can be coupled to a processor, such that the processor can read information from the storage medium and can write information into the storage medium; alternatively, the storage medium may be a component of the processor. The processor and the storage medium may reside in an ASIC. The software module may be stored in a memory of a mobile terminal, and may also be stored in a memory card that may be inserted into the mobile terminal. For example, if a device (such as the mobile terminal) adopts a large-capacity MEGA-SIM card or a large-capacity flash memory apparatus, the software module may be stored in the MEGA-SIM card or the large-capacity flash memory apparatus.

For one or more of the functional blocks and/or one or more combinations of the functional blocks described in the accompanying drawings, the functional blocks may be implemented as a general-purpose processor, a digital signal processor (DSP), an application-specific integrated circuit (ASIC), a field-programmable gate array (FPGA) or other programmable logic devices, discrete gate or transistor logic devices, discrete hardware assemblies, or any suitable combination thereof for executing the functions described in the present disclosure. One or more of the functional blocks and/or one or more combinations of the functional blocks described for the accompanying drawings may also be implemented as a combination of computing devices, e.g., a combination of DSPs and microprocessors, a plurality of microprocessors, one or more microprocessors in communication connection with the DSPs, or any other such configuration.

The present disclosure has been described above in conjunction with specific embodiments, but it should be clear to a person skilled in the art that these illustrations are exemplary and are not intended to limit the scope of protection of the present disclosure. A person skilled in the art could make various variations and modifications to the present disclosure according to the spirit and principle of the present disclosure, and these variations and modifications are also within the scope of the present disclosure.

1. A method for measurement gap configuration, which is applied to a network device, wherein the method comprises:
configuring at least one measurement gap corresponding to a reference signal time-domain position of an inter-frequency neighboring cell, wherein the reference signal is configured with at least one time offset for performing inter-frequency neighboring cell measurement; and
sending gap configuration information (GapConfig) to the terminal device, wherein the gap configuration information (GapConfig) comprises configuration information of the at least one measurement gap.

2. The method according to claim 1, wherein configuring the at least one measurement gap corresponding to the reference signal time-domain position of the inter-frequency neighboring cell, comprises:
configuring at least one piece of sub-gap configuration information in the gap configuration information (GapConfig), the at least one sub-gap having same measurement gap period;
wherein each piece of sub-gap configuration information is configured to determine a measurement gap having one time offset in the measurement gap period.

3. The method according to claim 2, wherein configuring at least one piece of sub-gap configuration information in the gap configuration information (GapConfig), comprises:
setting a sub-gap configuration information list in the gap configuration information (GapConfig), wherein the sub-gap configuration information list comprises at least one piece of sub-gap configuration information.

4. The method according to claim 2, wherein the sub-gap configuration information at least comprises: a measurement gap start time offset.

5. The method according to claim 4, wherein the sub-gap configuration information further comprises at least one of: a measurement gap length and an advance amount of measurement gap start time.

6. The method according to claim 1, wherein configuring the at least one measurement gap corresponding to the reference signal time-domain position of the inter-frequency neighboring cell, comprises:
associating at least one piece of gap configuration information (GapConfig) in the measurement object;
wherein each piece of gap configuration information (GapConfig) corresponds to a measurement gap having one time offset.

7. The method according to claim 6, wherein associating at least one piece of gap configuration information (GapConfig) in the measurement object, comprises:
configuring a measurement gap identifier list in the measurement object, wherein the measurement gap identifier list comprises at least one measurement gap identifier, and each measurement gap identifier indicates one piece of gap configuration information (GapConfig); or
configuring at least one measurement gap identifier in the measurement object, wherein each measurement gap identifier indicates one piece of gap configuration information (GapConfig).

8. The method according to claim 1, wherein configuring the at least one measurement gap corresponding to the reference signal time-domain position of the inter-frequency neighboring cell, comprises:
configuring measurement gap period configuration information and an indication information element;
wherein a measurement gap period indicated by the measurement gap period configuration information is smaller than a reference signal period of a cell on a frequency to be measured; and
the indication information element is configured to indicate whether measurement the at least one measurement gap in the measurement gap period is valid.

9. A method for measurement gap configuration, which is applied to a terminal device, wherein the method comprises:
receiving gap configuration information (GapConfig) sent from a network device, wherein the gap configuration information (GapConfig) comprises configuration information of at least one measurement gap corresponding to a reference signal time-domain position of an inter-frequency neighboring cell, and the reference signal is configured with at least one time offset;
determining the at least one measurement gap according to the gap configuration information (GapConfig); and
in the at least one measurement gap, measuring the reference signal of the inter-frequency neighboring cell.

10. The method according to claim 9, wherein determining the at least one measurement gap, comprises:
the gap configuration information (GapConfig) comprising at least one piece of sub-gap configuration information, wherein the at least one sub-gap has same measurement gap period; and
determining a measurement gap having one time offset in the measurement gap period according to the at least one piece of sub-gap configuration information.

11. The method according to claim 9, wherein determining the measurement gap, comprises:
receiving a measurement object sent by the network device, wherein at least one piece of gap configuration information (GapConfig) is associated in the measurement object, wherein each piece of gap configuration information (GapConfig) corresponds to a measurement gap having one time offset; and
determining a measurement gap according to the at least one piece of gap configuration information (GapConfig) associated in the measurement object.

12. The method according to claim 11, wherein determining the measurement gap according to the at least one piece of gap configuration information (GapConfig) associated in the measurement object, comprises:
the measurement object comprising a measurement gap identifier list, or the measurement object comprising at least one measurement gap identifier, wherein the measurement gap identifier list comprises at least one measurement gap identifier, and each measurement gap identifier indicates one piece of gap configuration information (GapConfig); and
determining a measurement gap according to the at least one measurement gap identifier.

13. The method according to claim 9, wherein determining the measurement gap, comprises:
receiving measurement gap period configuration information and an indication information element sent by the network device, wherein a measurement gap period indicated by the measurement gap period configuration information is smaller than a reference signal period of a cell on a frequency to be measured; and
according to the indication information element, determining a valid measurement gap in the reference signal period of the cell on the frequency to be measured.

14. A terminal device comprising a memory, a processor and a computer program stored on the memory, wherein the computer program, when executed by the processor, causes the terminal device to perform operations comprising:
receiving gap configuration information (GapConfig) sent from a network device, wherein the gap configuration information (GapConfig) comprises configuration information of at least one measurement gap corresponding to a reference signal time-domain position of an inter-frequency neighboring cell, and the reference signal is configured with at least one time offset;
determining the at least one measurement gap according to the gap configuration information (GapConfig); and
in the at least one measurement gap, measuring the reference signal of the inter-frequency neighboring cell.

15. The terminal device according to claim 14, wherein determining the at least one measurement gap, comprises:
the gap configuration information (GapConfig) comprising at least one piece of sub-gap configuration information, wherein the at least one sub-gap has same measurement gap period; and
determining a measurement gap having one time offset in the measurement gap period according to the at least one piece of sub-gap configuration information.

16. The terminal device according to claim 14, wherein determining the at least one measurement gap, comprises:
receiving a measurement object sent by the network device, wherein at least one piece of gap configuration information (GapConfig) is associated in the measurement object, and each piece of gap configuration information (GapConfig) corresponds to a measurement gap having one time offset; and
determining the at least one measurement gap according to the at least one piece of gap configuration information (GapConfig) associated in the measurement object.

17. The terminal device according to claim 16, wherein determining the at least one measurement gap according to the at least one piece of gap configuration information (GapConfig) associated in the measurement object, comprises:
the measurement object comprising a measurement gap identifier list, or the measurement object comprising at least one measurement gap identifier, wherein the measurement gap identifier list comprises at least one measurement gap identifier, and each measurement gap identifier indicates one piece of gap configuration information (GapConfig); and
determining the at least one measurement gap according to the at least one measurement gap identifier.

18. The terminal device according to claim 14, wherein determining the at least one measurement gap, comprises:
receiving measurement gap period configuration information and an indication information element sent by the network device, wherein a measurement gap period indicated by the measurement gap period configuration information is smaller than a reference signal period of a cell on a frequency to be measured; and
according to the indication information element, determining at least one valid measurement gap in the reference signal period of the cell on the frequency to be measured.
